(19) United States
(12) Patent Application Publication
(10) Pub. No.: US 2017/0168562 A1
(43) Pub. Date: Jun. 15, 2017

(54) DISPLAY DEVICE, METHOD OF CONTROLLING DISPLAY DEVICE, AND PROGRAM

(71) Applicant: SEIKO EPSON CORPORATION, Tokyo (JP)

(72) Inventors: Kaori SENDAI, Okaya-shi (JP); Atsunari TSUDA, Suwa-shi (JP); Masahide TAKANO, Matsumoto-shi (JP)

(73) Assignee: SEIKO EPSON CORPORATION, Tokyo (JP)

(21) Appl. No.: 15/327,139

(22) PCT Filed: Jul. 24, 2015
(86) PCT No.: PCT/JP2015/003718

§ 371 Date: Jan. 18, 2017

(30) Foreign Application Priority Data
Jul. 31, 2014 (JP) 2014-156646

(51) Int. Cl. G06F 3/01; G06F 3/00; G02B 27/01; G06T 11/60

(52) U.S. Cl. CPC G06F 3/013; G06T 11/60; G06F 3/002; G02B 27/0172; G02B 2027/0138; G02B 2027/014

(57) ABSTRACT

A head mounted display device is used by being mounted on a body of a user and includes an image display unit through which outside scenery is transmitted and that displays an image such that the image is visually recognizable together with the outside scenery. Further, the head mounted display device includes a target detection unit that detects a target of the user in a visual line direction and a position detection unit that detects a position of the target with respect to a display region of the image display unit. Further, the head mounted display device includes an information display control unit that determines a display position of information based on a position of the target detected by the position detection unit and allows the image display unit to display information.

### TECHNICAL FIELD

The present invention relates to a display device, a method of controlling a display device, and a program.

### BACKGROUND ART

In the related art, as a display device, a wearable display device having a function of displaying sentences is known (see PTL 1). The device disclosed in PTL 1 changes display attributes such as the font size or the color of characters of some characters or words in sentence data such that a user can easily grasp the contents of displayed sentence data. Accordingly, it is possible to more quickly and easily identify, for example, some characters in the sentence.

### CITATION LIST

### Patent Literature

PTL 1: JP-A-2014-56217

### SUMMARY OF INVENTION

### Technical Problem

In the device disclosed in PTL 1, the display attributes are changed corresponding to the contents of information to be displayed such that the font size or the like of words expressing a specific field is increased. Meanwhile, in the related art, there has been no technique of performing display corresponding to external circumstances of the device or the user that uses the device. For example, the locations or the circumstances of the wearable display device being used have not been considered.

### Solution to Problem

An advantage of some aspects of the invention is to provide a display device that displays information corresponding to external factors outside of the device, a method of controlling a display device, and a program.

An aspect of the invention is directed to a display device which is used by being mounted on a body of a user, including: a display unit through which outside scenery is transmitted and that displays an image such that the image is visually recognizable together with the outside scenery; a target detection unit that detects a target of the user in a visual line direction; a position detection unit that detects a position of the target with respect to a display region of the display unit; and an information display control unit that determines a display position of information based on the position of the target detected by the position detection unit and allows the display unit to display information.

According to the aspect of the invention, since the information is displayed corresponding to the target of the user on which the display device is mounted in the visual line direction, the information can be displayed by adjusting the appearance of the outside scenery seen by the user and the information to be displayed. Accordingly, it is possible to display the information so as to be easily seen corresponding to the external factors outside of the display device.

The display device may further include an imaging unit that images the visual line direction of the user and the target detection unit may detect the target that is visually recognized by the user through the display unit based on the captured image of the imaging unit.

According to the aspect of the invention with this configuration, it is possible to more reliably detect the target in the visual line direction.

In the display device, the position detection unit may detect the position of the target based on the captured image of the imaging unit.

According to the aspect of the invention with this configuration, it is possible to rapidly acquire the position of the target with respect to the display region.

In the display device, the position detection unit may detect the position of the target based on a plurality of pieces of information including the captured image of the imaging unit.

According to the aspect of the invention with this configuration, it is possible to more accurately acquire the position of the target with respect to the display region.

In the display device, the information display control unit may allow the display unit to display additional information related to the target detected by the target detection unit.

According to the aspect of the invention with this configuration, it is possible to display the additional information related to the target such that the additional information can be seen together with the target by the user.

In the display device, the position detection unit may detect a position in which the user visually recognizes the target through the display region of the display unit.

According to the aspect of the invention with this configuration, it is possible to display the information using the position in which the target is visually recognized by the user as a reference. For example, it is possible to display the information so as to overlap the target or display the information in a position that avoids the target.

In the display device, the information display control unit may allow information to be displayed such that the display region is overlapped with the position of the target detected by the position detection unit.

According to the aspect of the invention with this configuration, it is possible to display information such that the information is seen in a state of being overlapped with the target.

The display device may further include a distance detection unit that detects a distance between the target and the user, and the information display control unit may determine a display mode of information and may allow the display unit to display the information in a determined display mode according to the distance detected by the distance detection unit.

According to the aspect of the invention with this configuration, it is possible to change the display mode corresponding to the positional relationship between the target and the user.

Another aspect of the invention is directed to a method of controlling a display device which includes a display unit through which outside scenery is transmitted and that displays an image such that the image is visually recognizable together with the outside scenery and is used by being mounted on a body of a user, the method including: detecting a target of the user in a visual line direction; detecting a position of the target with respect to a display region of the display unit; and determining a display position of information based on the position of the target and allowing the display unit to display information.

According to the aspect of the invention, since the information is displayed corresponding to the target of the user on which the display device is mounted in the visual line direction, the information can be displayed by adjusting the appearance of the outside scenery seen by the user and the information to be displayed. Accordingly, it is possible to display the information so as to be easily seen corresponding to the external factors outside of the display device.

Still another aspect of the invention is directed to a program which can be executed by a computer controlling a display device that includes a display unit through which outside scenery is transmitted and that displays an image such that the image is visually recognizable together with the outside scenery and is used by being mounted on a body of a user, the program causing the computer to function as: a target detection unit that detects a target of the user in the visual line direction; a position detection unit that detects a position of the target with respect to a display region of the display unit; and an information display control unit that determines a display position of information based on the position of the target detected by the position detection unit and allows the display unit to display the information.

According to the aspect of the invention, since the information is displayed corresponding to the target of the user on which the display device is mounted in the visual line direction, the information can be displayed by adjusting the appearance of the outside scenery seen by the user and the information to be displayed. Accordingly, it is possible to display the information so as to be easily seen corresponding to the external factors outside of the display device.

### BRIEF DESCRIPTION OF DRAWINGS

FIG. 1 is a view illustrating an external configuration of a head mounted display device.

FIG. 2 is a block diagram illustrating a functional configuration of the head mounted display device.

FIG. 3 is a flowchart illustrating an operation of the head mounted display device.

FIG. 4 is a flowchart specifically illustrating a target detecting process.

FIG. 5 is a flowchart specifically illustrating a displaying process.

FIG. 6A is a view illustrating a typical application example of the head mounted display device, and is a view schematically illustrating a configuration of a theater in which the head mounted display device is used.

FIG. 6B is a view illustrating a typical application example of the head mounted display device, and illustrates an example of the field of vision of a user that uses the head mounted display device in the theater.

FIG. 6C is a view illustrating a typical application example of the head mounted display device, and illustrates an example of the field of vision of a user that uses the head mounted display device in the theater.

FIG. 6D is a view illustrating a typical application example of the head mounted display device, and illustrates an example of the field of vision of a user that uses the head mounted display device in the theater.

FIG. 7A is a view illustrating a typical application example of the head mounted display device, and illustrates an example of the field of vision of the user that uses the head mounted display device in the theater.

FIG. 7B is a view illustrating a typical application example of the head mounted display device, and illustrates an example of the field of vision of the user that uses the head mounted display device in the theater.

### DESCRIPTION OF EMBODIMENTS

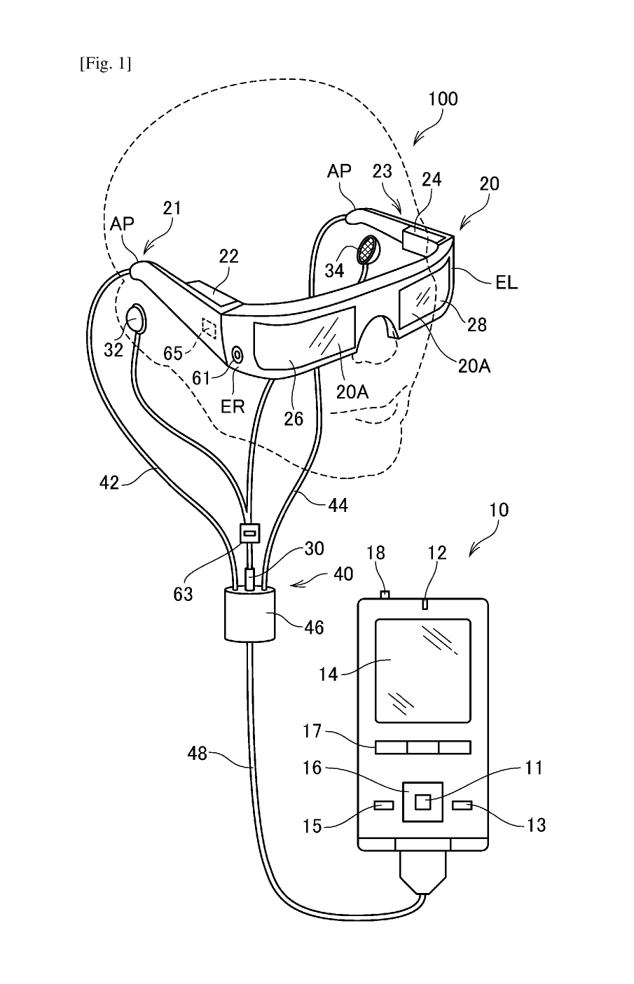

FIG. 1 is an explanatory view illustrating an external configuration of a head mounted display device 100. The head mounted display device 100 is a display device that is mounted on a head and referred to as a head mounted display (HMD). The head mounted display device 100 according to the present embodiment is an optical transmission type head mounted display device in which the outside scenery can be directly visually recognized at the same time as when a virtual image is visually recognized by a user. Further, in the present specification, the virtual image visually recognized by the user using the head mounted display device 100 is conveniently referred to as a “display image.” Further, emitting image light generated based on image data is expressed as “displaying an image.”

The head mounted display device 100 includes an image display unit 20 that allows the user to visually recognize a virtual image in a state in which the head mounted display device is mounted on the head of the user and a control device 10 that controls the image display unit 20. The control device 10 functions as a controller used for the user to operate the head mounted display device 100. The image display unit 20 is also simply referred to as a “display unit.”

The image display unit 20 is a mounted body to be mounted on the head of the user and has a shape of glasses in the present embodiment. The image display unit 20 includes a right holding unit 21, a right display driving unit 22, a left holding unit 23, a left display driving unit 24, a right optical image display unit 26, a left optical image display unit 28, a camera 61 (imaging unit), and a microphone 63. The right optical image display unit 26 and the left optical image display unit 28 are respectively arranged so as to be positioned in front of right and left eyes of the user when the image display unit 20 is mounted on the head of the user. One end of the right optical image display unit 26 and one end of the left optical image display unit 28 are connected to each other in a position corresponding to a place between eyebrows of the user when the image display unit 20 is mounted on the head of the user.

The right holding unit 21 is a member provided in a state of being extended from an end portion ER which is the other end of the right optical image display unit 26 to a position corresponding to a side head portion of the user when the image display unit 20 is mounted on the head of the user. Similarly, the left holding unit 23 is a member provided in a state of being extended from an end portion EL which is the other end of the left optical image display unit 28 to a position corresponding to a side head portion of the user when the image display unit 20 is mounted on the head of the user. The right holding unit 21 and the left holding unit 23 hold the image display unit 20 on the head portion of the user in a shape of temples (bows) of glasses.

The right display driving unit 22 and the left display driving unit 24 are arranged on the side facing the head portion of the user when the image display unit 20 is mounted on the user. Hereinafter, the right holding unit 21 and the left holding unit 23 are simply and collectively referred to as “holding units,” the right display driving unit 22 and the left display driving unit 24 are simply and collectively referred to as “display driving units,” and the right optical image display unit 26 and the left optical image display unit 28 are simply and collectively referred to as “optical image display units.”

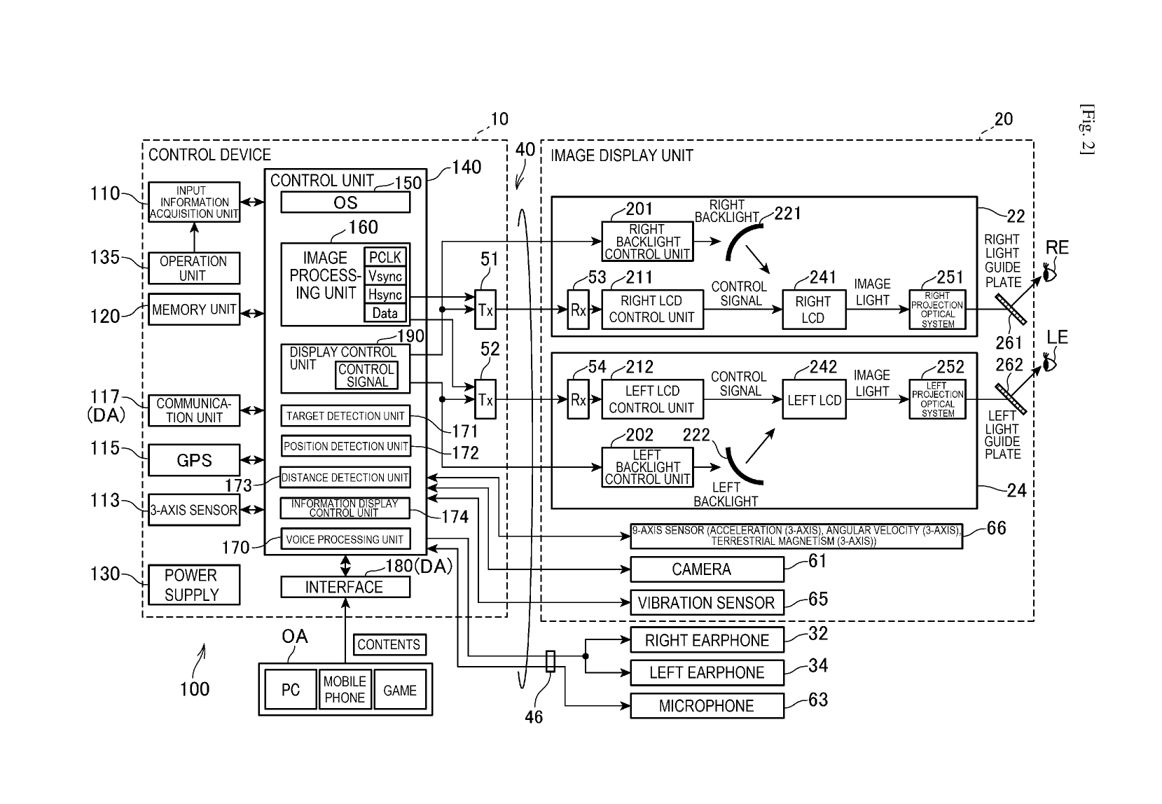

The display driving units 22 and 24 include liquid crystal displays 241 and 242 (hereinafter, also referred to as “LCDs 241 and 242”) or projection optical systems 251 and 252 (see FIG. 2). The details of the configurations of the display driving units 22 and 24 will be described below. The optical image display units 26 and 28 serving as optical members include light guide plates 261 and 262 (see FIG. 2) and a light adjusting plate 20A. The light guide plates 261 and 262 are formed of a resin with optical transparency or the like and guide image light output from the display driving units 22 and 24 to the eyes of the user. The light adjusting plate 20A is a thin plate-like optical element and is arranged so as to cover the front side of the image display unit 20 which is the opposite side of the eyes of the user. As the light adjusting plate 20A, various plates such as a plate with substantially no optical transparency, a nearly transparent plate, a plate through which light is transmitted by attenuating the amount of light, and a plate that attenuates or reflects light with a specific wavelength can be used. By suitably selecting optical characteristics (optical transmittance and the like) of the light adjusting plate 20A, the amount of external light which is incident to the right optical image display unit 26 and the left optical image display unit 28 from the outside is adjusted and thus ease of visual recognition of a virtual image can be adjusted. In the present embodiment, a case in which the light adjusting plate 20A having optical transparency at least to the extent that the outside scenery can be visually recognized by the user on which the head mounted display device 100 is mounted is used is described. The light adjusting plate 20A protects the right light guide plate 261 and the left light guide plate 262 so that damage of the right light guide plate 261 and the left light guide plate 262 and adhesion of dirt thereto are suppressed. The light adjusting plate 20A can be detachably attached to the right optical image display unit 26 and the left optical image display unit 28, plural kinds of light adjusting plates 20A are replaceable and can be mounted, or the light adjusting plate may be omitted.

The camera 61 is arranged in the end portion ER which is the other end of the right optical image display unit 26. The camera 61 images the outside scenery which is the outside view in a direction on the opposite side of the eyes of the user and acquires an image of the outside scenery. The camera 61 of the present embodiment illustrated in FIG. 1 is a single-lens camera, but may be a stereo camera.

An imaging direction, that is, the angle of view of the camera 61 is a front side direction of the head mounted display device 100, in other words, a direction in which at least a part of the outside scenery in the visual field direction of the user is imaged in a state of the head mounted display device 100 being mounted on the user. Further, the range of the angle of view of the camera 61 can be suitably set, but it is preferable that the imaging range of the camera 61 is a range including the outside world (outside scenery) that is visually recognized by the user through the right optical image display unit 26 and the left optical image display unit 28. Further, it is more preferable that the imaging range of the camera 61 is set such that the entire visual field of the user through the light adjusting plate 20A can be imaged.

The image display unit 20 further includes a connecting unit 40 that connects the image display unit 20 with the control device 10. The connecting unit 40 includes a main cord 48 connected to the control device 10, a right cord 42, a left cord 44, and a coupling member 46. The right cord 42 and the left cord 44 are cords in which the main cord 48 is branched into two cords. The right cord 42 is inserted into a housing of the right holding unit 21 from the tip portion AP of the right holding unit 21 in the extension direction and connected to the right display driving unit 22. Similarly, the left cord 44 is inserted into a housing of the left holding unit 23 from the tip portion AP of the left holding unit 23 in the extension direction and connected to the left display driving unit 24.

The coupling member 46 is provided in a branch point of the main cord 48, the right cord 42, and the left cord 44 and has a jack that connects an earphone plug 30. A right earphone 32 and a left earphone 34 are extended from the earphone plug 30. The microphone 63 is provided in the vicinity of the earphone plug 30. The cords are combined into one cord from the earphone plug 30 to the microphone 63, branched from the microphone 63, and respectively connected to the right earphone 32 and the left earphone 34.

The specific specification of the microphone 63 is optional. The microphone 63 may be a directional microphone or a nondirectional microphone. Examples of the directional microphone include a cardioid microphone, a supercardioid microphone, a hypercardioid microphone, and an ultracardioid microphone. In a case where the microphone 63 has directivity, the microphone may have a configuration in which the voice from the visual line direction of the user on which the head mounted display device 100 is mounted is particularly excellently collected and then detected. In this case, the microphone 63 or a component accommodating the microphone 63 may have structural characteristics in order to secure the directivity of the microphone 63. For example, in the example of FIG. 1, the microphone 63 and the coupling member 46 may be designed such that a sound collecting unit of the microphone 63 is directed to the visual line direction of the user in a state of the user on which the right earphone 32 and the left earphone 34 are mounted. Alternatively, the microphone 63 may be disposed by being embedded in the right holding unit 21 or the left holding unit 23. In this case, when a hole for collecting sound is formed on the front surface side of the right holding unit 21 or the left holding unit 23, that is, a surface which is located parallel to the right optical image display unit 26 and the left optical image display unit 28, the microphone can have directivity corresponding to the visual line direction of the user. The visual line direction of the user is, in other words, a direction in which the right optical image display unit 26 and the left optical image display unit 28 face, a direction toward the center of the visual field which is seen by the user over the right optical image display unit 26 and the left optical image display unit 28, or an imaging direction of the camera 61. In addition, the direction of the directivity of the microphone 63 may vary. In this case, the microphone may have a configuration in which the visual line direction of the user is detected and the visual line direction of the microphone 63 is adjusted so as to face the direction.

In addition, the right cord 42 and the left cord 44 can be combined into one cord. A conductive wire in the inside of the right cord 42 is drawn into the left holding unit 23 side through the inside of the main body of the image display unit 20 and coated with a resin together with a conductive wire in the inside of the left cord 44, and both cords may be combined into one cord.

The image display unit 20 and the control device 10 transmit various signals through the connecting unit 40. The end portion on the opposite side of the coupling member 46 in the main cord 48 and the control device 10 are respectively provided with connectors (not illustrated) engaged with each other. The control device 10 and the image display unit 20 are connected with each other or separated from each other due to engagement or disengagement of the connector of the main cord 48 and the connector of the control device 10. For example, metal cables or optical fibers can be applied to the right cord 42, the left cord 44, and the main cord 48.

The control device 10 is a device that controls the head mounted display device 100. The control device 10 includes switches having a determination key 11, a lighting unit 12, a display switching key 13, a brightness switching key 15, a direction key 16, a menu key 17, and a power supply switch 18. Further, the control device 10 includes a trackpad 14 that is manipulated by a touch operation of the user using a finger.

The determination key 11 outputs a signal that detects a pressing operation and determines the content operated by the control device 10. The lighting unit 12 notifies an operation state of the head mounted display device 100 according to the light emission state thereof. As the operation state of the head mounted display device 100, an On or Off state of the power supply can be exemplified. For example, a light emitting diode (LED) is used as the lighting unit 12. The display switching key 13 detects the pressing operation and outputs a signal that switches the display mode of a content video with 3D or 2D.

The trackpad 14 detects the operation of the user using a finger of the user on the operation surface of the trackpad 14 and outputs a signal according to the detected contents. As the trackpad 14, various trackpads such as an electrostatic trackpad, a pressure detecting trackpad, and an optical trackpad can be employed. The brightness switching key 15 detects a pressing operation and outputs a signal that increases or decreases the brightness of the image display unit 20. The direction key 16 detects the pressing operation on the key corresponding to the vertical direction and the horizontal direction and outputs a signal according to the detected contents. The power supply switch 18 switches the power supply state of the head mounted display device 100 by detecting a slide operation of the switch.

FIG. 2 is a functional block diagram of respective units constituting a display system 1 according to the present embodiment.

As illustrated in FIG. 2, the display system 1 includes an external device OA and the head mounted display device 100. Examples of the external device OA include a personal computer (PC), a mobile phone terminal, and a game terminal. The external device OA is used as an image supply device that supplies an image to the head mounted display device 100.

The control device 10 of the head mounted display device 100 includes a control unit 140, an operation unit 135, an input information acquisition unit 110, a memory unit 120, a power supply 130, an interface 180, a transmission unit (Tx) 51, and a transmission unit (Tx) 52.

The operation unit 135 detects the operation of the user. The operation unit 135 includes respective units such as the determination key 11, the display switching key 13, the trackpad 14, the brightness switching key 15, the direction key 16, the menu key 17, and the power supply switch 18 illustrated in FIG. 1.

The input information acquisition unit 110 acquires a signal according to an operation input performed by the user. As the signal according to the operation input, an operation input with respect to the trackpad 14, the direction key 16, or the power supply switch 18 can be exemplified.

The power supply 130 supplies power to respective units of the head mounted display device 100. As the power supply 130, for example, a secondary battery can be used.

The memory unit 120 stores various computer programs. The memory unit 120 is configured of a ROM or a RAM. The memory unit 120 may store image data displayed on the image display unit 20 of the head mounted display device 100.

The interface 180 is an interface for connecting various external devices OA serving as sources of supplying contents to the control device 10. As the interface 180, for example, an interface corresponding to the wired connection such as a USB interface, a micro USB interface, and an interface for a memory card can be used.

The control unit 140 realizes the functions of respective units by reading and executing the computer programs stored in the memory unit 120. That is, the control unit 140 functions as an operating system (OS) 150, an image processing unit 160, a voice processing unit 170, a target detection unit 171, a position detection unit 172, a distance detection unit 173, an information display control unit 174, and a display control unit 190.

A 3-axis sensor 113, a GPS 115, and a communication unit 117 are connected to the control unit 140. The 3-axis sensor 113 is a 3-axis acceleration sensor and a detection value of the 3-axis sensor 113 can be acquired by the control unit 140. The GPS 115 includes an antenna (not illustrated), receives a global positioning system (GPS) signal, and acquires the current position of the control device 10. The GPS 115 outputs the current position or the current time acquired based on the GPS signal to the control unit 140. Further, the GPS 115 acquires the current time based on information included in the GPS signal and may have a function of correcting the time clocked by the control unit 140 of the control device 10.

The communication unit 117 performs wireless data communication in conformity with standards such as a wireless LAN (WiFi (registered trademark)), Miracast (registered trademark), and Bluetooth (registered trademark).

In a case where the external device OA is connected to the communication unit 117 in a wireless manner, the control unit 140 acquires content data from the communication unit 117 and performs control for displaying an image on the image display unit 20. Meanwhile, in a case where the external device OA is connected to the interface 180 in a wired manner, the control unit 140 acquires content data from the interface 180 and performs control for displaying an image on the image display unit 20. Accordingly, hereinafter, the communication unit 117 and the interface 180 are collectively referred to as data acquisition units DA.

The data acquisition units DA acquire the content data to be displayed by the head mounted display device 100 from the external device OA. The content data includes display data described below and the display data can be used as various kinds of data such as image data or text data.

The image processing unit 160 acquires an image signal included in the contents. The image processing unit 160 separates a synchronization signal such as a vertical synchronization signal VSync or a horizontal synchronization signal HSync from the acquired image signal. Further, the image processing unit 160 generates a clock signal PCLK using a phase locked loop (PLL) circuit (not illustrated) or the like according to the frequency of the separated vertical synchronization signal VSync or horizontal synchronization signal HSync. The image processing unit 160 converts an analog image signal from which a synchronization signal is separated to a digital image signal using an A/D conversion circuit (not illustrated) or the like. Next, the image processing unit 160 stores the converted digital image signal in a DRAM of the memory unit 120 for each frame as image data (in the figure, Data) of the target image. The image data is, for example, RGB data.

In addition, the image processing unit 160 may perform image processing, for example, various color tone correction processing such as resolution conversion processing and adjusting the brightness or saturation, and keystone correction processing with respect to the image data as needed.

The image processing unit 160 transmits each of the generated clock signal PCLK, the vertical synchronization signal VSync, the horizontal synchronization signal HSync, and image data Data stored in the DRAM of the memory unit 120 through the transmission units 51 and 52. The image data Data transmitted through the transmission unit 51 is referred to as “image data for the right eye” and the image data Data transmitted through the transmission unit 52 is referred to as “image data for the left eye.” The transmission units 51 and 52 function as a transceiver for serial transmission between the control device 10 and the image display unit 20.

The display control unit 190 generates a control signal that controls the right display driving unit 22 and the left display driving unit 24. Specifically, the display control unit 190 individually controls, with the control signal, ON/OFF driving of a right LCD 241 using a right LCD control unit 211; ON/OFF driving of a right backlight 221 using a right backlight control unit 201; ON/OFF driving of a left LCD 242 using a left LCD control unit 212; and ON/OFF driving of a left backlight 222 using a left backlight control unit 202. In this manner, the display control unit 190 controls generation and emission of image light using each of the right display driving unit 22 and the left display driving unit 24. For example, the display control unit 190 allows both of the right display driving unit 22 and the left display driving unit 24 to generate image light, allows only one of the right display driving unit 22 and the left display driving unit 24 to generate image light, or allows both not to generate image light.

The display control unit 190 respectively transmits the control signals to the right LCD control unit 211 and the left LCD control unit 212 through the transmission units 51 and 52. In addition, the display control unit 190 respectively transmits the control signals to the right backlight control unit 201 and the left backlight control unit 202.

The image display unit 20 includes the right display driving unit 22, the left display driving unit 24, the right light guide plate 261 serving as the right optical image display unit 26, the left light guide plate 262 serving as the left optical image display unit 28, the camera 61, a vibration sensor 65, and a 9-axis sensor 66.

The vibration sensor 65 is configured using an acceleration sensor and is arranged in the inside of the image display unit 20 as illustrated in FIG. 1. In the right holding unit 21 of the example of FIG. 1, the vibration sensor 65 is incorporated in the vicinity of the end portion ER of the right optical image display unit 26. In a case where the user performs an operation of knocking the end portion ER, the vibration sensor 65 detects the vibration caused by the operation and outputs the detected results to the control unit 140. The control unit 140 detects the knocking operation of the user using the detected results of the vibration sensor 65.

The 9-axis sensor 66 is a motion sensor that detects the acceleration (3-axis), the angular velocity (3-axis), and the terrestrial magnetism (3-axis). Since the 9-axis sensor 66 is provided in the image display unit 20, the 9-axis sensor detects the motion of the head of the user when the image display unit 20 is mounted on the head of the user. Since the orientation of the image display unit 20 can be seen from the detected motion of the head of the user, the control unit 140 can assume the visual line direction of the user.

The right display driving unit 22 includes a receiving unit (Rx) 53; a right backlight (BL) control unit 201 and a right backlight (BL) 221 functioning as light sources; a right LCD control unit 221 and a right LCD 241 functioning as display elements; and a right projection optical system 251. The right backlight control unit 201 and the right backlight 221 function as light sources. The right LCD control unit 211 and the right LCD 241 function as display elements. In addition, the right backlight control unit 201, the right LCD control unit 211, the right backlight 221, and the right LCD 241 are also collectively referred to as “image light generation units.”

The receiving unit 53 functions as a receiver for serial transmission between the control device 10 and the image display unit 20. The right backlight control unit 201 drives the right backlight 221 based on the input control signal. The right backlight 221 is a light emitting body such as an LED or electroluminescence (EL). The right LCD control unit 211 drives the right LCD 241 based on the clock signal PCLK input through the receiving unit 53, the vertical synchronization signal VSync, the horizontal synchronization signal HSync, and image data Data 1 for a right eye. The right LCD 241 is a transmissive liquid crystal panel in which a plurality of pixels are arranged in a matrix.

The right projection optical system 251 is configured of a collimating lens that makes image light emitted from the right LCD 241 into a parallel light flux. The right light guide plate 261 serving as the right optical image display unit 26 guides the image light output from the right projection optical system 251 to a right eye RE of the user while reflecting the image light along a predetermined optical path. Further, the right projection optical system 251 and the right light guide plate 261 are also collectively referred to as “light guide units.”

The left display driving unit 24 has a configuration which is the same as that of the right display driving unit 22. The left display driving unit 24 includes a receiving unit (Rx) 54; a left backlight (BL) control unit 202 and a left backlight (BL) 222 functioning as light sources; a left LCD control unit 212 and a left LCD 242 functioning as display elements; and a left projection optical system 252. The left backlight control unit 202 and the left backlight 222 function as light sources. The left LCD control unit 212 and the left LCD 242 function as display elements. In addition, the left backlight control unit 202, the left LCD control unit 212, the left backlight 222, and the left LCD 242 are also collectively referred to as “image light generation units.” The left projection optical system 252 is configured of a collimating lens that makes image light emitted from the left LCD 242 into a parallel light flux. The left light guide plate 262 serving as the left optical image display unit 28 guides the image light output from the left projection optical system 252 to a left eye LE of the user while reflecting the image light along a predetermined optical path. Further, the left projection optical system 252 and the left light guide plate 262 are also collectively referred to as “light guide units.”

The head mounted display device 100 displays display data so as to overlap the outside scenery in a case where the user sees the outside scenery through the right optical image display unit 26 and the left optical image display unit 28.

The target detection unit 171 performs control of allowing the camera 61 to image the target and acquires the captured image. The captured image is output from the camera 61 as colored image data or monochrome image data, but the camera 61 outputs the image signal and the target detection unit 171 may generate the image data conforming to a predetermined file format from the image signal.

The target detection unit 171 analyzes the acquired captured image data and detects the target reflected on the captured image data. The target is an object or a person present in the imaging direction of the camera 61, that is, the visual line direction of the user.

The position detection unit 172 detects the position of the target detected by the target detection unit 171 with respect to the display region in which an image is displayed by the image display unit 20. The image displayed by the right optical image display unit 26 and the left optical image display unit 28 is visually recognized by both eyes of the user and the image is overlapped with external light transmitted through the light adjusting plate 20A. Accordingly, the user visually recognizes the outside scenery in an overlapped manner with the image displayed by the right optical image display unit 26 and the left optical image display unit 28. Here, the range in which an image displayed by the right optical image display unit 26 and the left optical image display unit 28 is seen by the user is set as a display region of the image display unit 20. The display region is the maximum range in which the image displayed by the image display unit 20 can be visually recognized and the image display unit 20 displays an image in the whole or a part of the display region.

The position detection unit 172 acquires the relative position between the position in which the target is seen by the user and the position in which the image displayed by the image display unit 20 is seen based on the position of the image of the target in the captured image of the camera 61. In this process, information showing a positional relationship between the display region of the image display unit 20 and the imaging range (angle of view) of the camera 61 is required. In place of the information, information showing a positional relationship between the visual field (field of vision) of the user and the imaging range (angle of view) of the camera 61 and information showing a positional relationship between the visual field (field of vision) of the user and the display region of the image display unit 20 may be used. The information is stored in the memory unit 120 in advance.

Further, the position detection unit 172 may detect the position of the target and the size of the target with respect to the display region. In this manner, in a case where the image displayed by the image display unit 20 and the target in the outside scenery are seen by the user, the image can be displayed such that the size of the displayed image and the target image perceived by the user becomes a predetermined state.

When the image display unit 20 displays an image based on the position of the target detected by the position detection unit 172, data can be displayed by avoiding the position in which the user sees the target or data can be displayed so as to overlap the position in which the user sees the target.

The distance detection unit 173 acquires the distance to the target detected by the target detection unit 171. For example, the distance detection unit 173 acquires the distance to the target based on the size of the target image detected by the target detection unit 171 in the captured image of the camera 61.

Further, the head mounted display device 100 may include a distance meter that detects the distance to the target using laser light or ultrasonic waves. The distance meter includes a light source of laser light and a light receiving unit that receives reflected light of laser light emitted from the light source and detects the distance to the target based on a state in which laser light is received. Moreover, the distance meter may be, for example, an ultrasonic wave type distance meter. That is, a distance meter that includes a sound source emitting ultrasonic waves and a detection unit detecting ultrasonic waves reflected by the target and detecting the distance to the target based on the reflected ultrasonic waves may be used. Further, the distance meter can have a configuration in which a distance meter using laser light and a distance meter using ultrasonic waves are combined with each other. It is preferable that such a distance meter is provided in the right holding unit 21 of the image display unit 20 or the right display driving unit 22 and the distance meter may be disposed, for example, in a surface linearly arranged with the light adjusting plate 20A in a state of being directed to the front side. It is preferable that the direction in which the distance meter measures the distance is a visual line direction of the user similar to the imaging direction of the camera 61.

The distance detection unit 173 detects the distance to the target from the camera 61 or the distance meter, but the distance can be regarded as the distance from the user of the head mounted display device 100 to the target.

The information display control unit 174 allows the image display unit 20 to display display data based on the processing results of the target detection unit 171, the position detection unit 172, and the distance detection unit 173. The head mounted display device 100 may acquire various kinds of data such as moving images, still images, characters, and symbols using the data acquisition unit DA and the data can be used as display data.

The information display control unit 174 determines display attributes of the display data based on the position and/or the size detected by the position detection unit 172 related to the target detected by the target detection unit 171 and the distance to the target detected by the distance detection unit 173. The display attributes include the presence of character decoration such as the display size of characters, display colors, fonts, bold characters, or italic characters in a case where the display data is text data. Further, images having square, oval, and circular shapes can be arranged as the background of the character data and the display attributes may include the presence of the background, the size of the background, the shape, and the transparency of the background. In the case where the display data is image data, the display attributes include the display size, the display color, and the transparency of the image.

The head mounted display device 100 displays display data so as to be visually recognized by the user together with the outside scenery using the function of the information display control unit 174.

The voice processing unit 170 acquires a voice signal included in the contents, amplifies the acquired voice signal, and supplies the voice signal to a speaker (not illustrated) in the right earphone 32 and a speaker (not illustrated) in the left earphone 34 connected to the coupling member 46. Further, in a case where a Dolby (registered trademark) system is employed, processing with respect to the voice signal is performed and different sounds whose frequencies or the like are changed are output from each of the right earphone 32 and the left earphone 34.

Further, the voice processing unit 170 performs processing related to a voice by acquiring the voice collected by the microphone 63 and converting the voice to digital voice data. For example, the voice processing unit 170 recognizes individual voices of a plurality of people and may perform speaker recognition that identifies a person who is speaking for each voice by extracting characteristics from the acquired voices and modeling the voices.

The 3-axis sensor 113, the GPS 115, and the communication unit 117 are connected to the control unit 140. The 3-axis sensor 113 is the 3-axis acceleration sensor and the control unit 140 can detect the motion of the control device 10 and the direction of the motion by acquiring the detection value of the 3-axis sensor 113.

The GPS 115 includes an antenna (not illustrated), receives a global positioning system (GPS) signal, and acquires the current position of the control device 10. The GPS 115 outputs the current position or the current time acquired based on the GPS signal to the control unit 140. Further, the GPS 115 acquires the current time based on information included in the GPS signal and may have a function of correcting the time clocked by the control unit 140 of the control device 10.

The communication unit 117 performs wireless data communication in conformity with standards such as a wireless LAN (WiFi (registered trademark)) and Bluetooth (registered trademark).

The interface 180 is an interface for connecting various image supply devices OA serving as sources of supplying contents to the control device 10. The contents supplied by the image supply device OA include moving images or still images and may include voices. As the image supply device OA, a personal computer (PC), a mobile phone terminal, or a game terminal can be exemplified. As the interface 180, for example, a USB interface, a micro USB interface, an interface for a memory card or the like can be used.

Here, the image supply device OA can be connected to the control device 10 using a wireless communication line. In this case, the image supply device OA performs wireless communication with the communication unit 117 and transmits content data using a wireless communication technique such as Miracast (registered trademark).

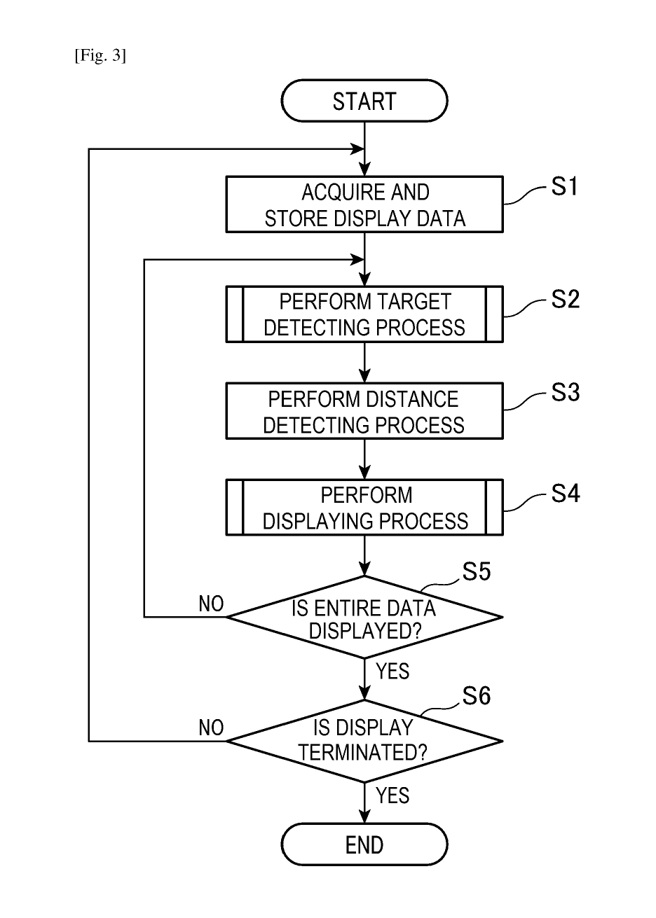

FIG. 3 is a flowchart illustrating the operation of the head mounted display device 100 and particularly illustrating a data displaying process using a function of the information display control unit 174. The data displaying process is a process in which display data such as characters related to the outside scenery is displayed by the image display unit 20 when the user sees the outside scenery through the right optical image display unit 26 and the left optical image display unit 28.

First, the control unit 140 of the head mounted display device 100 acquires the display data using the data acquisition unit DA (Step S1). The data acquired by the data acquisition unit DA is stored in the memory unit 120. The data received in Step S1 can be used as various kinds of data such as moving image data, still image data, and text data and an example in which text data formed of a character array is acquired or displayed will be described in the present embodiment.

Next, the target detection unit 171 performs a target detecting process (Step S2). The target detection unit 171 detects an image of the target from the captured image of the camera 61 and the position detection unit 172 detects the position of the target. Subsequently, the distance detection unit 173 performs a distance detecting process that detects the distance to the target detected by the target detection unit 171 (Step S3). Further, the information display control unit 174 performs a displaying process, controls the display control unit 190 based on the results of the processes of the target detection unit 171, the position detection unit 172, and the distance detection unit 173, and allows the image display unit 20 to display the display data (Step S4). Respective processes of Steps S2 and S4 will be described below.

Next, the control unit 140 determines whether the entirety of data acquired in Step S1 is processed in Steps S2 to S4 (Step S5). In a case where unprocessed data is present (Step S5: NO), the process returns to Step S2 and the control unit 140 performs a process on the unprocessed data. Further, in a case where the process on the entirety of data is terminated (Step S5: YES), the control unit 140 determines whether to finish displaying the data (Step S6). In the case where displaying of the data is continued (Step S6: NO), the process of the control unit 140 returns to Step S1. Further, in a case where displaying of the data is finished according to the operation or the like detected by the operation unit 135 (Step S6: YES), the control unit 140 stops displaying and finishes the main process using the display control unit 190.

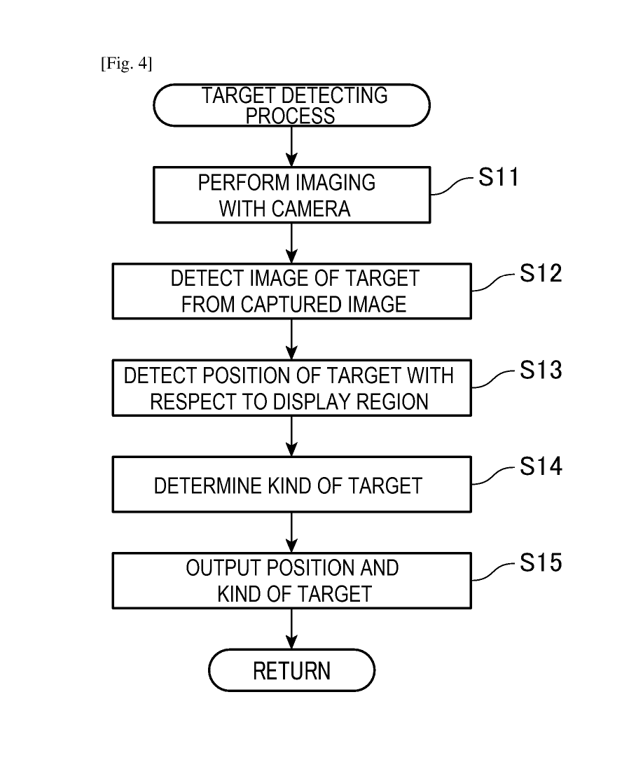

FIG. 4 is a flowchart specifically illustrating the target detecting process illustrated in Step S2 of FIG. 3.

The target detection unit 171 acquires the captured image by allowing the camera 61 to capture an image (Step S11) and detects an image of the target from the captured image (Step S12). As the process of detecting the target by the target detection unit 171, two processes can be exemplified. A first process is a process of using data which shows characteristics of the image of the detected target and is stored in the memory unit 120 in advance. Specifically, the target detection unit 171 acquires data showing characteristics of the image from the memory unit 120 and searches a part matching the characteristics in the captured image. The target detected in the first process is a target matching the data stored in the memory unit 120 in advance. A second process is a process of cutting out an image of a person or an object reflected in the captured image by the target detection unit 171 extracting the contour thereof in the captured image and setting the cut-out image as an image of a target in a case where an image having a predetermined size or greater is cut out. In a case where images with a plurality of targets are detected in the first and second processes, the target detection unit 171 may select one target closer to the visual line direction of the user. For example, an image of a target close to the center in the captured image of the camera 61 may be selected.

Next, the position detection unit 172 detects the position with respect to the display region in regard to the image of the target detected by the target detection unit 171 (Step S13). In Step S13, the position detection unit 172 suitably acquires information or the like showing the positional relationship between the display region and the angle of view of the camera 61 from the memory unit 120 as described above.

In addition, the target detection unit 171 determines the kind of target based on the image of the target detected in Step S12 (Step S14). In the present embodiment, as the kind of target, two kinds of targets, that is, a target which is not overlapped with the display data and a target which is overlapped with the display data can be exemplified. Here, the target which is overlapped with the display data is referred to as a background.

Moreover, the position detection unit 172 outputs the position of the target detected in Step S13, the target detection unit 171 outputs the kind of target determined in Step S14, and the process moves to Step S3 (FIG. 3) (Step S15).

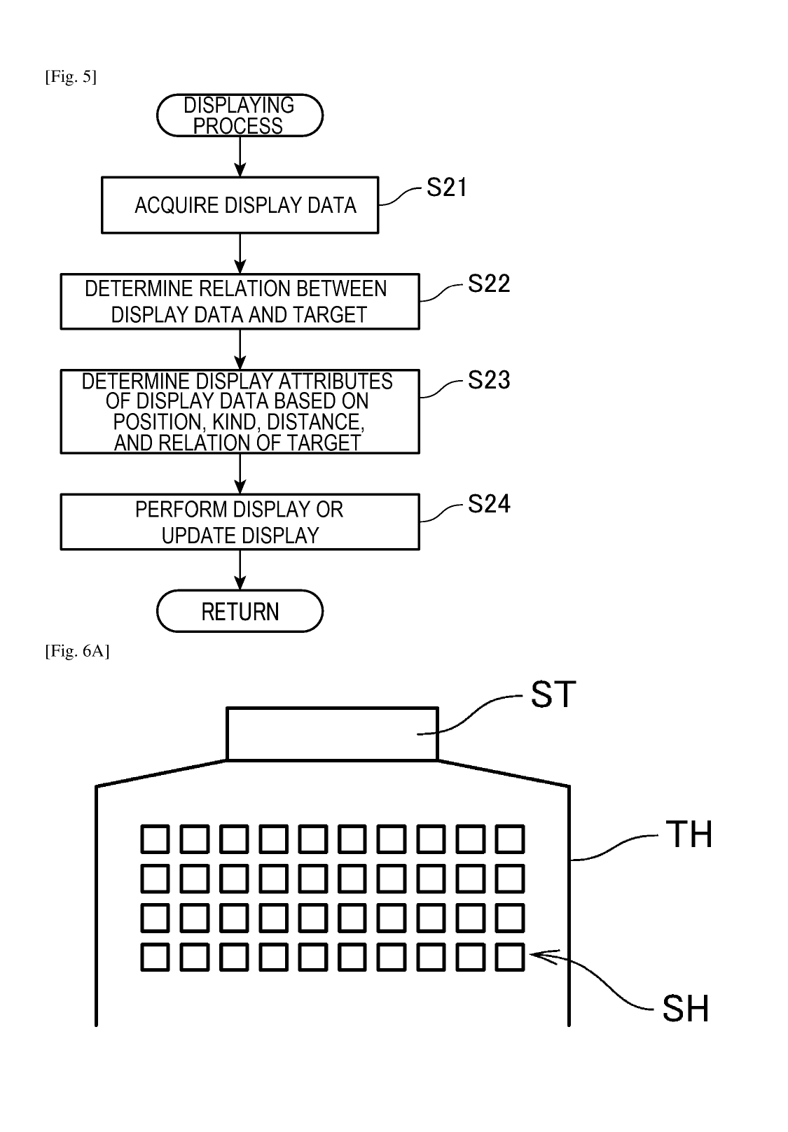

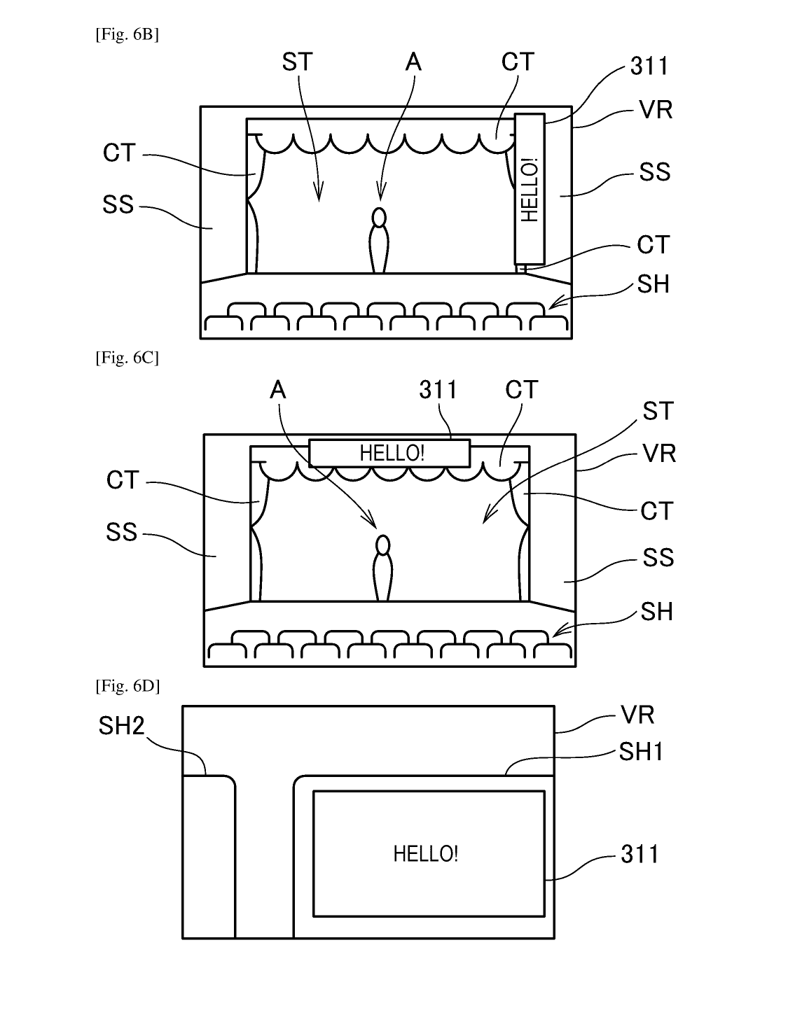

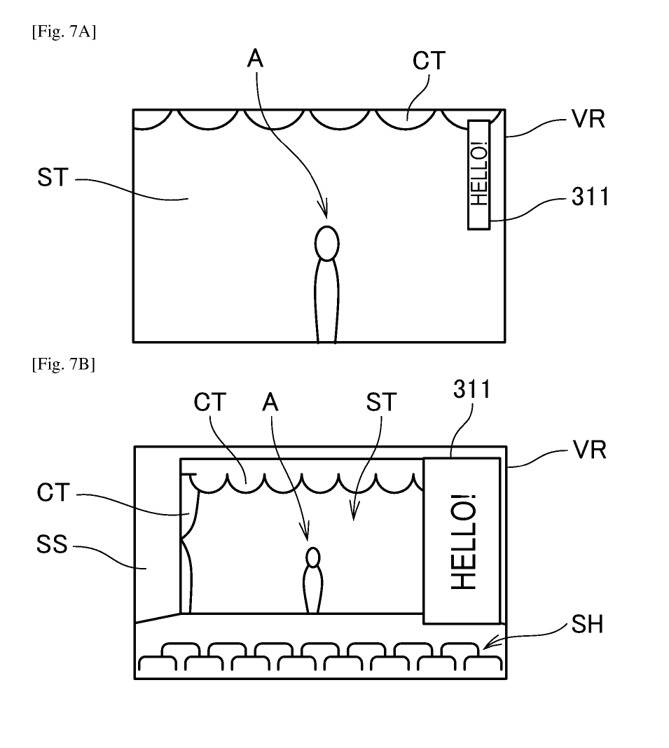

FIG. 5 is a flowchart illustrating the displaying process in detail. Further, FIGS. 6A to 7B are explanatory views illustrating typical application examples of the head mounted display device 100. FIG. 6A is a view schematically illustrating a configuration of a theater TH for which the head mounted display device 100 is used and FIGS. 6B, 6C, 6D, 7A, and 7B illustrate examples of field of vision VR of the user using the head mounted display device 100 in the theater TH.

The theater TH illustrated in FIG. 6A has a configuration in which plural seats SH for the audience including the user of the head mounted display device 100 such that the seats SH are directed to a stage ST. the user of the head mounted display device 100 uses the head mounted display device 100 at the time of seeing the stage ST while being seated on the seat SH.

The field of vision VR in FIG. 6B indicates the field of vision which is seen by the user over the right optical image display unit 26 and the left optical image display unit 28 of the image display unit 20. Since the image display unit 20 has a characteristic in which the image display unit 20 can be visually recognized through the outside scenery, the stage ST can be seen from the field of vision VR. The field of vision VR includes a curtain CT arranged above the stage ST and the left and right ends thereof and stage wings SS arranged on the left and right sides of the stage ST. An actor A is seen from the stage ST. In the example, the actor A is on the stage ST and seen by the user.

In this example, the display data acquired by the control unit 140 in Step S1 is text data related to a play program staged on the theater TH and includes text of description related to the lines spoken by the actor A and the play program. The control unit 140 acquires text data of the entire play program or a part thereof in Step S1. In a case where the text data includes plural lines and/or plural text of description, the display data acquired in Step S1 is displayed by being divided in plural times in accordance with the progression of the play program. Accordingly, the information display control unit 174 acquires the display data by extracting display data by an amount of data to be displayed this time from the display data acquired in Step S1 (Step S21). The information display control unit 174 acquires display data in accordance with the progression of the play program. For example, in a case where data showing the timing of displaying the text data is added to the display data together with the text data, the information display control unit 174 extracts the display data based on the added data.

The information display control unit 174 determines the presence of a relation between the acquired display data and the target detected by the target detection unit 171 (Step S22). For example, in a case where data showing that the data is the lines of the play program or the text of description is added to the text data included in the display data, if the target is the actor A and the acquired display data is the lines, the information display control unit 174 determines that the display data and the target are related. In a case where target detection unit 171 determines that the target is not the background, the target can be specified as the actor A.

The information display control unit 174 determines display attributes of the display data (Step S23). Specifically, the display attributes are determined based on the position of the target detected by the position detection unit 172, the kind of target determined by the target detection unit 171, the distance to the target detected by the distance detection unit 173, and the presence of the relation between the target searched in Step S22 and the display data. Next, the information display control unit 174 outputs the determined display attributes and the display data to the display control unit 190, allows the image display unit 20 to display the data, updates the display while performing the display (Step S24), and the process proceeds to Step S5 (FIG. 3).

In the example of FIG. 6B, since the target detected by the target detection unit 171 is the actor A and there is no background, the text 311 is displayed such that the actor A is not overlapped with the position in which the user visually recognizes the actor A. That is, a position which is not overlapped with the actor A is determined as the display position included in the display attributes of the text 311. In the example of FIG. 6B, a position which is overlapped with the curtain CT on the stage wings SS is determined as the display position of the text 311. Further, as illustrated in FIG. 6C, a position which is overlapped with the curtain CT above the stage ST may be determined as the display position of the text 311. The information display control unit 174 may set the size such that the actor A is not overlapped with the stage ST as the display size included in the display attributes. Further, when the color of the curtain CT is the same as that of the characters of the text 311, since the visibility of the text 311 is degraded, a background having a predetermined color is added to the text 311. Further, in the examples of FIGS. 6B and 6C, since the text 311 is the lines of the actor A, the text 311 is related to the actor A serving as the target. Therefore, the information display control unit 174 adds character decoration to the characters to more stand out as the display attributes of the text 311 or sets the display color as a color to more stand out in the captured image of the camera 61.

Meanwhile, in a case where the target detection unit 171 determines that the detected target as the background, the text 311 is displayed in a position overlapped with the target as illustrated in FIG. 6D. In the example of FIG. 6D, front seats SH1 are in the range of the field of vision VR and the seats SH1 are detected as the target. The target detection unit 171 recognizes that the seats SH1 are the target which is not related with a person based on the shape or the color and determines the target as the background. In this case, the information display control unit 174 determines the display size and the position of the text 311 such that the seats SH1 which are the target are overlapped with the position.

FIGS. 7A and 7B illustrate an example in which the information display control unit 174 determines the display attributes based on the distance detected by the distance detection unit 173.

FIG. 7A illustrates an example in a case where the distance detected by the distance detection unit 173 is shorter than a predetermined distance and the text 311 is displayed such that the text 311 can be seen to be small and bright. Meanwhile, FIG. 7B illustrates an example in a case where the distance detected by the distance detection unit 173 is longer than the predetermined distance and the text 311 is displayed such that the text 311 can be seen to be large and dark. The brightness of the text 311 can be adjusted using the brightness of the character portion of the text 311 and the ratio of the color of the background (a square in this example) of the text 311 and the brightness of the text 311. In a case where the user is in a position close to the stage ST, the outside scenery which can be seen by the eyes of the user, that is, the stage ST is seen to be bright. Therefore, the visibility of the text 311 becomes excellent by making the text 311 brighter. In addition, since the actor A becomes difficult to be seen when the text 311 is displayed to be large such that the stage ST occupies most of the field of vision VR, it is preferable that the display size of the text 311 is reduced.

Meanwhile, as illustrated in FIG. 7B, in a case where the user is in a position separated from the stage ST, since the stage ST is seen to be dark, both of the stage ST and the text 311 can be excellently visibly recognized when the text 311 is displayed to be dark. Further, since the actor A is seen to be small, the possibility of the text 311 being overlapped with the actor A is small even when the text 311 is displayed to be large.

In this manner, the information display control unit 174 can display the display data so as to be easily seen without damaging the visibility of the outside scenery intended to be seen by the user according to the situation of the outside scenery visually recognized by the user.

In addition, in a theater in which an actor appears in a performance as the example illustrated in FIGS. 6 and 7, a display is disposed in the stage wings SS in some cases. In this kind of display, the voice (the lines or the like) uttered by an actor or the text related to the description of the play program is displayed. In the related art, a character array displayed in the above-described display can be displayed as the text 311 by the head mounted display device 100. Further, in a case where the display is disposed, the display is seen in the field of vision VR. In this case, the head mounted display device 100 sets the display as the target and may display the display data in a position which is not overlapped with the target. In this case, the target detection unit 171 detects both of the display and the actor A as the targets and the kind of each target may be determined. In addition, the information display control unit 174 may determine the display attributes of the text 311 corresponding to the kinds of all targets.

As described above, the head mounted display device 100 according to the embodiment to which the invention is applied includes the image display unit 20 which is used by being mounted on the body of the user and displays the image such that the image can be visually recognized together with the outside scenery through the outside scenery. Further, the head mounted display device 100 includes the target detection unit 171 that detects the target of the user in the visual line direction and the position detection unit 172 that detects the position of the target with respect to the display region of the image display unit 20. In addition, the head mounted display device includes the information display control unit 174 that determines the display position of information based on the position of the target detected by the position detection unit 172 and allows the image display unit 20 to display the information. In this manner, since the information is displayed corresponding to the target of the user on which the head mounted display device 100 is mounted in the visual line direction, the information can be displayed by adjusting the appearance of the outside scenery seen by the user and the information to be displayed. Accordingly, it is possible to display the information so as to be easily seen corresponding to the external factors outside of the head mounted display device 100.

Further, the head mounted display device 100 includes the camera 61 that images the visual line direction of the user and the target detection unit 171 detects the target visually recognized by the user through the image display unit 20 based on the captured image of the camera 61. Accordingly, the target in the visual line direction can be more reliably detected.

In addition, since the information display control unit 174 allows the image display unit 20 to display the additional information related to the target detected by the target detection unit 171, the additional information related to the target can be displayed so as to be seen by the user with the target. Here, in a case where the text 311 (FIG. 6B) or the like is displayed as the additional information, the display mode including the presence of character decoration such as the fonts of characters, the display color of characters, the display size, the background color, or the outline characters may be suitably changed by the information display control unit 174 according to the attributes of the additional information. In addition, the display mode of the additional information may be changed according to the state of the brightness or the like of external light incident to the target of the user in the visual line direction or to the image display unit 20 from the visual line direction of the user. Moreover, the information display control unit 174 may allow the user to visually recognize a threedimensional (3D) image by allowing an image having a parallex to be displayed by the right optical image display unit 26 and the left optical image display unit 28 when the additional image is displayed. In this case, whether to display the image as a stereoscopic image or a planar image may be set or changed by the information display control unit 174 as one of the display modes.

In addition, the position detection unit 172 detects the position in which the user visually recognizes the target through the display region of the image display unit 20. In this manner, the information can be displayed using the position in which the user visually recognizes the target as a reference. For example, as illustrated in FIGS. 6B and 6C, information can be displayed in the position avoiding the target.

Further, since the information display control unit 174 allows the information to be displayed such that the information is overlapped with the position of the target detected by the position detection unit 172, the information can be displayed so as to be seen with the target in an overlapped manner as illustrated in FIG. 6D.

In addition, the head mounted display device 100 includes the distance detection unit 173 that detects the distance between the target and the user and the information display control unit 174 determines the display mode of the information according to the distance detected by the distance detection unit 173 and allows the information to be displayed by the image display unit 20 in the determined display mode. Accordingly, the display mode can be changed according to the positional relationship between the target and the user.

Further, the invention is not limited to the configurations of the above-described embodiment and various modifications are possibly performed in the range without departing from the scope of the invention.

For example, in the above-described embodiment, the example in which the text 311 serving as the display data is displayed as a planar image has been described, but a part or the entire text may be displayed as a stereoscopic image. In this case, the information display control unit 174 may perform a process of determining whether to display the display data as a stereoscopic image or a planar image as one of the display attributes.

In addition, the description is made that the position detection unit 172 detects the position of the target based on the captured image of the camera 61, but the invention is not limited thereto. For example, the position detection unit 172 may detect the positon of the target based on a signal transmitted from another external device. Specifically, in a case where light beams (infrared rays or the like) in the outside of the visible region are sent from a device mounted on the target, the light beams are received and the position of the target may be detected. In place of the light beams, a wireless signal is sent from an external device, the head mounted display device 100 receives the wireless signal, and the position detection unit 172 may detect the position. A light beacon or a radio beacon in the related art can be employed as a specific example thereof. In this case, the distance between the target and the head mounted display device 100 may be detected. Further, the position of the target may be acquired based on the signal transmitted from the external device detecting the position of the target. Further, the position detection unit 172 may detect the position of the target based on a plurality of pieces of information such as a captured image of the camera 61, the light beams, or a signal.

In addition, the target detection unit 171 may detect the target of the user in the visual line direction and is not limited to a target detection unit detecting a target from the captured image of the camera 61. For example, the target detection unit 171 may detect the position of the target based on a signal transmitted from another external device. Specifically, in a case where light beams (infrared rays or the like) in the outside of the visible region are sent from a device mounted on the target, the light beams are received and the position of the target may be detected. In place of the light beams, a wireless signal is sent from an external device, the head mounted display device 100 receives the wireless signal, and the position detection unit 171 may detect the target. A light beacon or a radio beacon in the related art can be employed as a specific example thereof. In this case, the position detection unit 172 receives the light or the wireless signal as described above and may detect the position of the target.

In addition, the configurations of the target detection unit 171 and the position detection unit 172 are not limited to configurations realized as a part of the functions included in the control unit 140 as described above and may be one of a functional unit separately provided from the control unit 140 and a unit separately provided from the image display unit 20.

In addition, in place of the image display unit 20, an image display unit having another system such as an image display unit to be mounted on the head of the user, for example, a cap or the like may be employed as an image display unit and may include a display unit that displays an image corresponding to the left eye of the user and a display unit that displays an image corresponding to the right eye of the user. In addition, the display device according to the invention may be configured as a head mounted display to be installed in a vehicle such as an automobile or an airplane. In addition, for example, the display device may be configured as a head mounted display built in a body-protecting tool such as a helmet or a head-up display (HUD) used for front glass of an automobile. A display for forming an image on retinas in the eyeballs of the user such as a so-called contact lens type display used by being mounted on both eyeballs (for example, on the cornea) of the user or an implantable display used by being embedded in the eyes may be used as the image display unit 20.

Further, the display device of the present application may be a device to be mounted on a body of a user and such a device can be applied regardless of whether support using another technique is necessary or not. For example, a binocular type hand held display used by being held with both hands of the user may be employed as the image display unit 20 of the present application. Such a display is included in the display device according to the invention because the device is put on the head or the face of the user when the user sees a displayed image of the display even though the user needs to hold the device by hand for holding the state of being mounted on the head of the user. In addition, a device which is put on the head or the face of the user when the user sees a displayed image of the display is included in the display device according to the invention even through the device is a display device to be fixed on a floor surface or a wall surface using support legs or the like.

In addition, only a display unit having a configuration of the image display unit 20 or a configuration according to the image display in the image display unit 20 is mounted on the body of the user and a control system including the display device 10 other than the display unit or the display device 10 and the control unit 140 may be configured as a physically separate body. For example, a device having another control system is connected to a display unit formed of the image display unit 20 or a part of the image display unit 20 in a wireless manner and may be set as a display device similar to the head mounted display device 100. Examples of the device having such a control system include a smartphone, a mobile phone, a tablet computer, a personal computer having another shape, and an existing electronic device. It is needless to say that the present application can be applied to such a display device.

In addition, in the above-described embodiment, the example of the configuration in which the image display unit 20 and the control device 10 are separated from each other and connected to each other through the connecting unit 40 has been described, but a configuration in which the control device 10 and the image display unit 20 are integrated with each other and mounted on the head of the user can be employed.

In addition, the control device 10 and the image display unit 20 are connected to each other through a longer cable or a wireless communication line and a mobile electronic device including a laptop computer, a tablet computer, a desktop computer, a game machine, a mobile phone, a smartphone, or a portable media player; or a dedicated device may be used as the control device 10.

In addition, for example, as a configuration of generating image light in the image display unit 20, a configuration that includes an organic electroluminescence (EL) display and an organic EL control unit may be employed and liquid crystal on silicon (LCoS; registered trademark), a digital micromirror device or the like can be used. Further, for example, the invention can be applied to a laser retina projection type head mounted display. That is, a configuration of allowing the user to visually recognize an image in a manner in which the image generation unit includes a laser light source and an optical system that guides the laser light source to the eyes of the user, the laser light is incident to the eyes of the user to scan the retinas, and an image is formed on the retinas. In a case where a laser retina projection type head mounted display is employed, the expression “a region in which image light in an image light generation unit can be emitted” can be defined as an image region to be visually recognized by the eyes of the user.

As an optical system that guides image light to the eyes of the user, a configuration that includes an optical member through which external light incident toward a device from the outside is transmitted and allows the image light and the external light to be incident to the eyes of the user can be employed. Further, an optical member that is positioned on the front side of the eyes of the user and overlapped with a part or the entire visual field of the user may be used. In addition, a scanning type optical system of scanning laser light or the like to be used as image light may be employed. Further, the optical system is not limited to an optical system of guiding image light in the inside of the optical member, and an optical system that has only a function of guiding image light toward the eyes of the user by refracting and/or reflecting the image light may be employed.

Moreover, the invention may be applied to a display device to which a scanning optical system using an MEMS mirror is employed and which uses an MEMS display technique. That is, as image display elements, the display device may include a signal light forming unit, a scanning optical system having an MEMS mirror that scans light emitted by the signal light forming unit, and an optical member on which a virtual image is formed due to light scanned by the scanning optical system. In this configuration, the light emitted by the signal light formation unit is reflected on the MEMS mirror to be incident on the optical member, guided through the optical member, and reaches a surface on which a virtual image is formed. A virtual image is formed on the surface on which a virtual image is formed by scanning the light using the MEMS mirror and an image is visually recognized by the user capturing the virtual image with the eyes. An optical component in this case may be a component that guides light after performing reflection plural times such as the right light guide plate 261 and the left light guide plate 262 according to the above described embodiment or a half mirror surface may be used.

In addition, the display device according to the invention is not limited to a head mounted display device and various display devices such as a flat panel display and a projector can be employed. The display device according to the invention may be a device that allows a user to visually recognize an image using external light and image light and a device having a configuration in which an image is visually recognized by the user due to an optical member through which the external light is transmitted using the image light can be exemplified. Specifically, the invention can be applied to a display device that projects image light on a transmissive flat surface or curved surface (glass or transparent plastic) which is fixedly or movably arranged on a position separated from the user in addition to the configuration including an optical member through which the external light is transmitted in the above-described head mounted display. As an example, a configuration of a display device that allows a user riding on a vehicle or a user outside the vehicle to visually recognize the scenery, other than the vehicle, together with an image due to image light by projecting the image light on window glass of the vehicle can be exemplified. Further, a configuration of a display device that allows a user present in the vicinity of a display surface to visually recognize the scenery through the display surface together with an image due to image light by projecting the image light on a transparent, semitransparent, or colored transparent display surface fixedly arranged such as window glass of a building can be exemplified.

Further, a configuration in which at least a part of each functional block illustrated in FIG. 2 may be realized in hardware or realized in cooperation of hardware and software may be employed. In addition, the configuration is not limited to a configuration in which independent hardware resources are arranged as illustrated in FIG. 2. In addition, a program executed by the control unit 140 may be stored in the memory unit 120 or a memory unit in the control device 10 or may be executed by acquiring a program stored in an external device through the communication unit 117 or the interface 180. In addition, only the operation unit 135 may be formed as a single user interface (UI) in a configuration formed in the control device 10 or the power supply 130 in the present embodiment may be singly formed and exchangeable. In addition, the configuration formed in the control device 10 may be repeatedly formed in the image display unit 20. For example, the control unit 140 illustrated in FIG. 2 may be formed in both of the control device 10 and the image display unit 20 or functions of the control unit 140 formed in the control device 10 and the CPU formed in the image display unit 20 may be separately divided.

### REFERENCE SIGNS LIST

10: Control device
20: Image display unit (display unit)
21: Right holding unit
22: Right display driving unit
23: Left holding unit
24: Left display driving unit
26: Right optical image display unit
28: Left optical image display unit
61: Camera (imaging unit)
63: Microphone
100: Head mounted display device (display device)
117: Communication unit
120: Memory unit
140: Control unit
150: Operating system
160: Image processing unit
170: Voice processing unit
171: Target detection unit
172: Position detection unit
173: Distance detection unit
174: Information display control unit
180: Interface
190: Display control unit
201: Right backlight control unit
202: Left backlight control unit
211: Right LCD control unit
212: Left LCD control unit
221: Right backlight
222: Left backlight
241: Right LCD
242: Left LCD
251: Right projection optical system
252: Left projection optical system
261: Right light guide plate
262: Left light guide plate
311: Text (display data)
DA: Data acquisition unit

1. A display device which is used by being mounted on a body of a user, comprising:
a display unit through which outside scenery is transmitted and that displays an image such that the image is visually recognizable together with the outside scenery;
a target detection unit that detects a target of the user in a visual line direction;
a position detection unit that detects a position of the target with respect to a display region of the display unit; and
an information display control unit that determines a display position of information based on the position of the target detected by the position detection unit and allows the display unit to display information.

2. The display device according to claim 1, further comprising an imaging unit that images the visual line direction of the user,
wherein the target detection unit detects the target that is visually recognized by the user through the display unit based on a captured image of the imaging unit.

3. The display device according to claim 2, wherein the position detection unit detects the position of the target based on the captured image of the imaging unit.

4. The display device according to claim 3, wherein the position detection unit detects the position of the target based on a plurality of pieces of information including the captured image of the imaging unit.

5. The display device according to claim 1, wherein the information display control unit allows the display unit to display additional information related to the target detected by the target detection unit.

6. The display device according to claim 1, wherein the position detection unit detects a position in which the user visually recognizes the target through the display region of the display unit.

7. The display device according to claim 6, wherein the information display control unit allows information to be displayed such that the display region is overlapped with the position of the target detected by the position detection unit.

8. The display device according to claim 1, further comprising a distance detection unit that detects a distance between the target and the user,
wherein the information display control unit determines a display mode of information and allows the display unit to display the information in a determined display mode according to the distance detected by the distance detection unit.

9. A method of controlling a display device which includes a display unit through which outside scenery is transmitted and that displays an image such that the image is visually recognizable together with the outside scenery and is used by being mounted on a body of a user, the method comprising:
detecting a target of the user in a visual line direction;
detecting a position of the target with respect to a display region of the display unit; and
determining a display position of information based on the position of the target and allowing the display unit to display information.

10. A program which can be executed by a computer controlling a display device that includes a display unit through which outside scenery is transmitted and that displays an image such that the image is visually recognizable together with the outside scenery and is used by being mounted on a body of a user, the program causing the computer to function as:
a target detection unit that detects a target of the user in the visual line direction;
a position detection unit that detects a position of the target with respect to a display region of the display unit; and
an information display control unit that determines a display position of information based on the position of the target detected by the position detection unit and allows the display unit to display the information.
